(19) United States
(12) Patent Application Publication
(10) Pub. No.: US 2026/0127028 A1
(43) Pub. Date: May 7, 2026

(54) APPARATUS AND METHOD FOR EFFICIENT SCHEDULING OF ACCELERATOR WORKLOADS

(71) Applicant: Intel Corporation, Santa Clara, CA (US)

(72) Inventor: Paul Murphy, Dublin (IE)

(73) Assignee: Intel Corporation, Santa Clara, CA (US)

(21) Appl. No.: 19/425,886

(22) Filed: Dec. 18, 2025

(51) Int. Cl. G06F 9/48

(52) U.S. Cl. CPC G06F 9/4881

(57) ABSTRACT

An apparatus and method for scheduling multiple contexts on a plurality of neural processing unit (NPU) tiles. One embodiment of an apparatus comprises: a plurality of neural processing unit (NPU) tiles; a scheduler to schedule a plurality of workloads for execution on the plurality of NPU tiles, the scheduler to: schedule a first workload associated with a first priority for execution on at least a first NPU tile of the plurality of NPU tiles; and responsive to an indication of a second workload associated with a second priority which is higher than the first priority submitted for execution, determining whether to: preempt the first workload, execute the second workload on a second NPU tile, or provide a grace period for the first workload to complete execution before executing the second workload on the first NPU tile.

### BACKGROUND

### Field of the Disclosure

This disclosure relates generally to the field of computer processors. More particularly, this disclosure relates to an apparatus and method for efficient scheduling of accelerator workloads.

### Description of the Related Art

In current silicon-on-chip (SoC) implementations, firmware is responsible for scheduling user contexts on accelerators such as neural processing units (NPUs). When making scheduling decisions regarding the user context to schedule next, the absolute and relative priorities of each user context and the allowed quantum of each user context are evaluated. However, only one user context is selected to run at a time, potentially leaving hardware resources under-utilized, even when other user contexts could be scheduled to make use of the unused resources.

In addition, the management algorithms to determine frequency and resource constraints of an NPU operate at a global level to control a single NPU frequency for all running workloads. For NPU devices which support concurrency, this means that lower priority work receives the benefit of higher frequencies of higher priority work executed in parallel, potentially working contrary to the expectation of the user who expected a lower power impact for the lower priority work. Additionally, the lower priority work may even compete with and slow down the higher priority work because it competes for shared resources.

In current implementations, workloads are scheduled on NPUs using the maximum available resources. Because no consideration is provided for reduced resource options which also meet the requirements of a given workload, the NPU scheduler must schedule the work on fixed, maximum resource requirements, resulting in higher power consumption and reduced performance due to preemption which is not needed to satisfy the workload requirements.

### BRIEF DESCRIPTION OF THE DRAWINGS

A better understanding of the present invention can be obtained from the following detailed description in conjunction with the following drawings, in which:

FIG. 1 illustrates an example processor or system-on-chip (SoC) including a neural processing unit (NPU) accelerator.

FIG. 2 illustrates an example NPU partitioned into a plurality of NPU tiles.

FIG. 3 illustrates an example accelerator workloads processing environment comprising sequences of operations of multiple user contexts, an NPU scheduler, and NPU hardware.

FIG. 4A illustrates an example of per-context timeout tracking for two user contexts.

FIG. 4B illustrates an example of per-context timeout tracking for three user contexts.

FIG. 5 illustrates an example power management subsystem including power circuits associated with an NPU, a host processor, and input-output (IO) circuitry.

FIG. 6 illustrates an implementation in which the frequency and voltage of each NPU tile can be independently adjusted.

FIG. 7A illustrates an SoC including techniques for communicating between an NPU and a CPU.

FIG. 7B illustrates an example in which a frame is generated by a graphics processing unit (GPU) and then processed by an NPU.

FIG. 8 illustrates an example indicating the state of a GPU and an NPU based on actions performed by an application.

FIG. 9 illustrates an example in which a grace period and context deadlines of accelerator workloads scheduling are determined for two contexts.

FIG. 10 illustrates an example with preemption in which a grace period and context deadlines of accelerator workloads scheduling are determined for two contexts.

FIG. 11 illustrates an example in which a grace period allows a context to complete without preemption by a higher priority context.

FIG. 12 illustrates a method for scheduling accelerator workloads on NPU tiles in accordance with one or more embodiments of this disclosure.

FIG. 13 illustrates a method in accordance with some embodiments of this disclosure in which additional resource allocations are performed based on quality-of-service (QoS) levels associated with different workloads

### DETAILED DESCRIPTION OF EMBODIMENTS

Disclosed herein are embodiments of instructions, embodiments of processors to perform the instructions, embodiments of methods performed by the processors when performing the instructions, embodiments of systems incorporating one or more processors to perform the instructions, and embodiments of programs or machine-readable mediums storing or otherwise providing the instructions. In the following description, numerous specific details are set forth (e.g., specific instruction operations, data formats, processor configurations, microarchitectural details, sequences of operations, etc.). However, embodiments may be practiced without these specific details. In other instances, well-known circuits, structures, and techniques have not been shown in detail to avoid obscuring the understanding of the description.

Implementations of this disclosure efficiently schedule multiple user contexts on an accelerator, such as a neural processing unit (NPU). Each application that uses a NPU runs in its own NPU context such as a state and a set of computing resources available for the application, which is referred to as “user context” from herein. Multiple user contexts can exist simultaneously if the NPU or other AI accelerators process workloads from multiple applications at once. In some implementations, the NPU includes front end circuitry including circuitry for executing scheduling firmware to schedule instructions of different user contexts on the execution resources of the NPU. The NPU execution resources may be partitioned into a plurality of NPU “tiles,” each of which can be independently allocated for processing instructions for a particular user context. The scheduling firmware can also monitor the current state of the NPU tiles to identify NPU tiles which become available for scheduling additional instructions associated with additional NPU contexts.

With an NPU scheduler and partitionable execution resources as described herein, the preemption of one user context for another can be avoided or significantly reduced. The scheduler attempts to schedule different types and/or combinations of workloads for concurrent execution when possible, significantly improving execution efficiency.

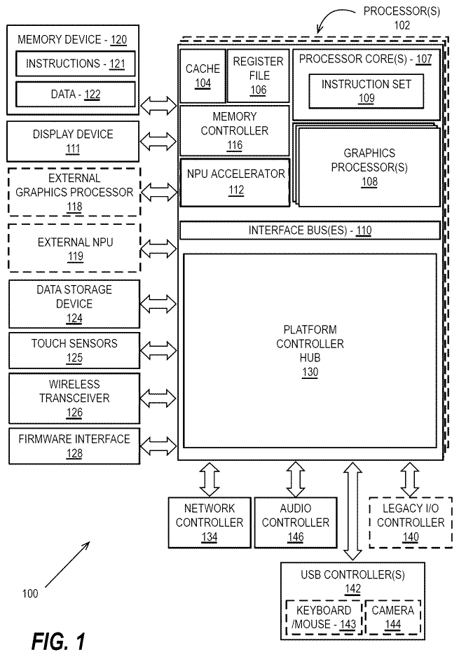

FIG. 1 is a block diagram of a processing system 100, according to some implementations. Processing system 100 may be used in a single processor desktop system, a multiprocessor workstation system, or a server system having a large number of processors 102 or processor cores 107. In one embodiment, the processing system 100 is a processing platform incorporated within a system-on-a-chip (SoC) integrated circuit for use in mobile, handheld, or embedded devices such as within Internet-of-things (IoT) devices with wired or wireless connectivity to a local or wide area network.

In one embodiment, the processing system 100 can include, couple with, or be integrated within: a server-based gaming platform; a game console, including a game and media console; a mobile gaming console, a handheld game console, or an online game console. In some embodiments the processing system 100 is part of a mobile phone, smart phone, tablet computing device or mobile Internet-connected device such as a laptop with low internal storage capacity. The processing system 100 can also include, couple with, or be integrated within: a wearable device, such as a smart watch wearable device; smart eyewear or clothing enhanced with augmented reality (AR) or virtual reality (VR) features to provide visual, audio or tactile outputs to supplement real world visual, audio or tactile experiences or otherwise provide text, audio, graphics, video, holographic images or video, or tactile feedback; other augmented reality (AR) device; or other virtual reality (VR) device. In some embodiments, the processing system 100 includes or is part of a television or set top box device. In one embodiment, the processing system 100 can include, couple with, or be integrated within a self-driving vehicle such as a bus, tractor trailer, car, motor or electric power cycle, plane, or glider (or any combination thereof). The self-driving vehicle may use the processing system 100 to process the environment sensed around the vehicle.

In some embodiments, the one or more processors 102 each include one or more processor cores 107 to process instructions which, when executed, perform operations for system or user software. In some embodiments, at least one of the one or more processor cores 107 is configured to process a specific instruction set 109. In some embodiments, instruction set 109 may facilitate Complex Instruction Set Computing (CISC), Reduced Instruction Set Computing (RISC), or computing via a Very Long Instruction Word (VLIW). One or more processor cores 107 may process a different instruction set 109, which may include instructions to facilitate the emulation of other instruction sets. Processor core 107 may also include other processing devices, such as a Digital Signal Processor (DSP).

In some embodiments, the processor 102 includes cache memory 104. Depending on the architecture, the processor 102 can have a single internal cache or multiple levels of internal cache. In some embodiments, the cache memory is shared among various components of the processor 102. In some embodiments, the processor 102 also uses an external cache (e.g., a Level-3 (L3) cache or Last Level Cache (LLC)) (not shown), which may be shared among processor cores 107 using known cache coherency techniques. A register file 106 can be additionally included in processor 102 and may include different types of registers for storing different types of data (e.g., integer registers, floating point registers, status registers, and an instruction pointer register). Some registers may be general-purpose registers, while other registers may be specific to the design of the processor 102.

In some embodiments, one or more processor(s) 102 are coupled with one or more interface bus(es) 110 to transmit communication signals such as address, data, or control signals between processor 102 and other components in the processing system 100. The interface bus 110, in one embodiment, can be a processor bus, such as a version of the Direct Media Interface (DMI) bus. However, processor busses are not limited to the DMI bus, and may include one or more Peripheral Component Interconnect buses (e.g., PCI, PCI express), memory busses, or other types of interface busses. In one embodiment the processor(s) 102 include a memory controller 116 and a platform controller hub 130. The memory controller 116 facilitates communication between a memory device and other components of the processing system 100, while the platform controller hub (PCH) 130 provides connections to I/O devices via a local I/O bus.

The memory device 120 can be a dynamic random-access memory (DRAM) device, a static random-access memory (SRAM) device, flash memory device, phase-change memory device, or some other memory device having suitable performance to serve as process memory. In one embodiment the memory device 120 can operate as system memory for the processing system 100, to store data 122 and instructions 121 for use when the one or more processors 102 executes an application or process. The memory controller 116 also couples with an optional external graphics processor 118, which may communicate with the one or more graphics processors 108 in processors 102 to perform graphics and media operations.

In some embodiments, graphics, media, and or compute operations may be assisted by a neural processing unit (NPU) accelerator 112 which may be implemented as a coprocessor configured to accelerate artificial intelligence (AI) and machine learning tasks by efficiently performing matrix arithmetic and parallel processing. For example, in one embodiment, the NPU accelerator 112 is designed to efficiently perform tensor operations, such as matrix multiplications and convolutions to improve the performance of machine learning and compute operations.

Some implementations include an NPU 119 external to the processor 102 and coupled to the processor 102 via high-speed channels (e.g., a PCIe 6.0 channels/links). The external NPU 119 may be used instead of the integrated NPU accelerator 112 or may operate in concert with the NPU accelerator 112.

In some embodiments a display device 111 can connect to the processor(s) 102. The display device 111 can be one or more of an internal display device, as in a mobile electronic device or a laptop device or an external display device attached via a display interface (e.g., DisplayPort, etc.). In one embodiment the display device 111 can be a head mounted display (HMD) such as a stereoscopic display device for use in virtual reality (VR) applications or augmented reality (AR) applications.

In some embodiments the platform controller hub 130 enables peripherals to connect to memory device 120 and processor 102 via a high-speed I/O bus. The I/O peripherals include, but are not limited to, an audio controller 146, a network controller 134, a firmware interface 128, a wireless transceiver 126, touch sensors 125, a data storage device 124 (e.g., non-volatile memory, volatile memory, hard disk drive, flash memory, NAND, 3D NAND, 3D XPoint, etc.). The data storage device 124 can connect via a storage interface (e.g., SATA) or via a peripheral bus, such as a Peripheral Component Interconnect bus (e.g., PCI, PCI express). The touch sensors 125 can include touch screen sensors, pressure sensors, or fingerprint sensors. The wireless transceiver 126 can be a Wi-Fi transceiver, a Bluetooth transceiver, or a mobile network transceiver such as a 3G, 4G, 5G, or Long-Term Evolution (LTE) transceiver. The firmware interface 128 enables communication with system firmware, and can be, for example, a unified extensible firmware interface (UEFI). The network controller 134 can enable a network connection to a wired network. In some embodiments, a high-performance network controller (not shown) couples with the interface bus 110. The audio controller 146, in one embodiment, is a multi-channel high-definition audio controller. In one embodiment the processing system 100 includes an optional legacy I/O controller 140 for coupling legacy (e.g., Personal System 2 (PS/2)) devices to the system. The platform controller hub 130 can also connect to one or more Universal Serial Bus (USB) controllers 142 to connect to input devices, such as keyboard and mouse 143 combinations, a camera 144, or other USB input devices.

It will be appreciated that the processing system 100 shown is exemplary and not limiting, as other types of data processing systems that are differently configured may also be used. For example, an instance of the memory controller 116 and platform controller hub 130 may be integrated into a discrete external graphics processor, such as the external graphics processor 118. In one embodiment the platform controller hub 130 and/or memory controller 116 may be external to the one or more processor(s) 102 and reside in a system chipset that is in communication with the processor(s) 102.

Thus, Neural Processing Units (NPUs), such as NPU accelerator 112 and external NPU 119 may be integrated into processors and systems to process AI workloads more efficiently.

### Efficient Concurrent Work Scheduling for User Contexts

In addition to scheduling concurrent user contexts, the baseline NPU scheduler may implement one or more of the following features:
Preemption: Preemption refers to halting the execution of the current context in favor of a new context.
Context switch: A context switch refers to halting the current context and saving the context state in memory or storage, loading the state of a new context from memory or storage to reconfigure the hardware, and executing the new context.
Priority scheduling: Priority scheduling refers to selecting the highest priority context for execution on the NPU ahead of all other work, potentially preempting a lower priority context if necessary.
Round-robin scheduling: With round-robin scheduling, each context has the same priority and is allocated the same quantum of execution time on the NPU.
Grace periods: A grace period refers to a current context being provided a fixed amount of time to complete work before preemption and a context switch occurs.

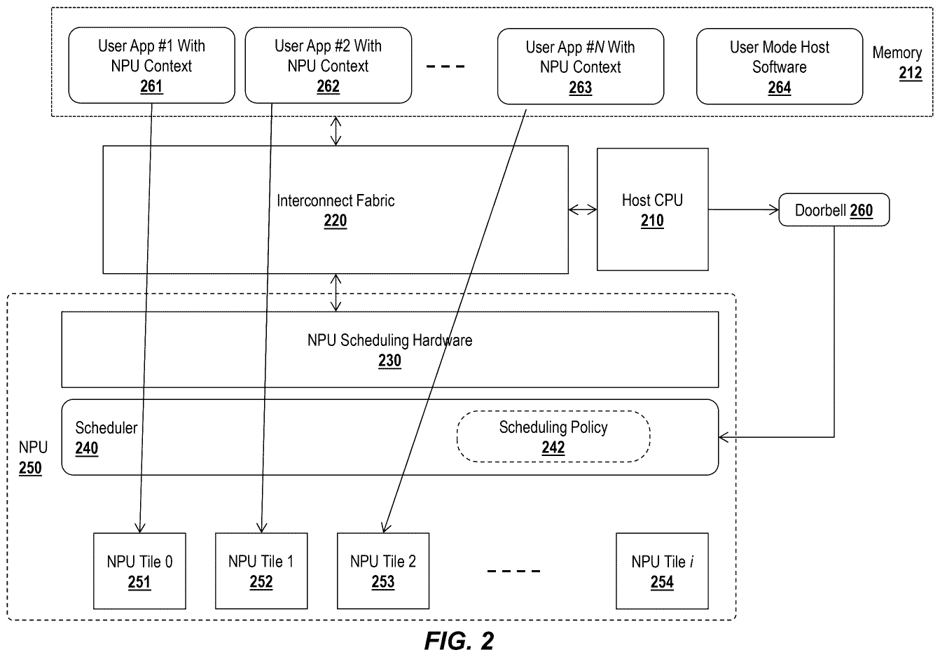

FIG. 2 illustrates an example architecture with a neural processing unit (NPU) 250 coupled to a host CPU 210 and a memory 212 via an interconnect fabric 220. The host CPU 210 includes a plurality of cores of a particular microarchitecture (e.g., ARM cores, x86 cores) and the interconnect fabric comprises any type of chip-level, package-level, or system-level interconnect (e.g., a PCIe interconnect with a plurality of PCIe links). The NPU 250, host CPU 210 and interconnect fabric 220 may be integrated on the same die (e.g., such as NPU 112), or may be arranged on separate dies in a multi-chip package or in separate components of a computer system. For example, the NPU may be a discrete processor integrated on a PCIe card and coupled to the host CPU 210 via a PCIe interface (e.g., such as NPU 119).

The NPU 250 can be any type of processor configured to perform data-parallel operations, such as tensor operations. The NPU, for example, may include a plurality of clusters of processing elements (also referred to as “compute units”) configured to operate in parallel on a large number of vector or tensor source values to generate vector or tensor results. By way of example, and not limitation, the NPU 250 may include an array of processing elements configured to perform matrix multiplication operations in which corresponding data elements of two input matrices (Matrices A and B) are multiplied to generate a plurality of products. The products are selectively added to corresponding accumulation values of an accumulation matrix (Matrix C) to generate corresponding result values in a result matrix (Matrix D). The NPU 250 may perform these operations, or a subset thereof, in parallel, across a plurality of lanes. In some implementations, the processing elements of the NPU are interconnected to form a systolic array in which the outputs of the each row of processing elements are used as inputs to processing elements in the next row of processing elements until the final row of processing elements outputs result values (e.g., with the products in each row being added to the corresponding values received from the prior row). Note, however, that the underlying principles of this disclosure are not limited to a systolic array implementation or any particular NPU architecture.

The host CPU 210 is configured to execute a plurality of user applications 261-264, some of which offload work to the NPU 250, represented as applications 261-263 with an “NPU context.” A scheduler 230 may retrieve work descriptors from the memory 212 which indicate the work to be performed and schedules the work on NPU tiles 251-254 in accordance with a specified scheduling policy, where each NPU “tile” comprises an apportionable subset of the NPU's execution resources. For example, each NPU tile may include a set of vector or tensor registers for storing tensor data elements corresponding to source and destination operands of vector/tensor instructions and execution circuitry (e.g., arithmetic logic units (ALUs)) for performing parallel vector/tensor operations (e.g., matrix multiplication and convolution operations) across a plurality of execution lanes. By way of example, and not limitation, each NPU tile 251-254 may include execution resources for processing source data elements across a defined number of lanes (e.g., 32, 64, or 128), with each lane having a defined bit width (e.g., 16 bits, 32 bits, etc). In some implementations, two or more NPU tiles may be combined to execute a single NPU context in parallel across a larger number of lanes.

In some implementations, the host CPU 210 may offload work to the NPU 250 by submitting work descriptors to work queues in memory 212 which specify the work to be performed by one or more of the NPU tiles 251-254. For example, a descriptor may be fetched from a work queue by the scheduler 240, which assigns the corresponding work to one or more of the NPU tiles 251-254 in accordance with the current scheduling policy 242 (some examples of which are provided herein).

In some embodiments, each application 261-263 indicates the specific NPU resources for which the work is compiled. Alternatively, or additionally, the NPU resources may be determined dynamically, by the scheduler 240 based on current workload and environmental conditions (e.g., the utilization level of all of the NPU tiles 251-254, the type of work requested, the thermal and power limits of the processor, etc.).

Each descriptor and corresponding work may have an associated priority band which may be determined by the applications 261-263, potentially in combination with the OS. The scheduler 240, in accordance with the current scheduling policy 242, may prioritize processing of higher priority descriptors ahead of lower priority descriptors. A different work queue may be configured in memory for each NPU context and/or each priority band. In some implementations, the scheduling policy 242 is configured with the objective of maximizing throughput and/or minimizing latency.

In some implementations, the NPU tiles 251-254 are configured to process descriptors and can be preempted individually. The number and type of NPU tiles 251-254 may vary based on the target platform and are not related to the number of applications with NPU contexts 261-263.

In one embodiment, each priority band has defined expectations, as set forth in Table A:

TABLE A

| Band | Preemption rule | Expectations |
|---|---|---|
| Idle | Preempts no other band | NPU frequency algorithm doesn't |
| | | consider time in this band towards |
| | | frequency increases; work has no |
| | | progress guarantees |
| Normal | Preempts every band | |
| | below this one | |
| Yielding | Preempts every band | |
| Realtime | below this one; if | |
| | normal work is pending | |
| | while this band is | |
| | running, then this | |
| | band yields a defined | |
| | percentage of the time | |
| | (e.g., 30%, 60%, etc.) | |
| Absolute | Preempts every band | |
| Realtime | below this one | |

Running user contexts concurrently is not always possible or beneficial. For example, if all work submitted consumes the full available execution resources of the NPU, then concurrency may not be possible. However, if work is compiled for a small number of resources such that it would be possible to have concurrent execution, then by modifying the basic NPU scheduling policy 242, the hardware utilization and efficiency can be increased.

In one specific scenario where concurrency is beneficial, the work is compiled for less than maximum number of NPU tiles 251-254, and the scheduler 240 allows for the concurrent selection of multiple NPU contexts.

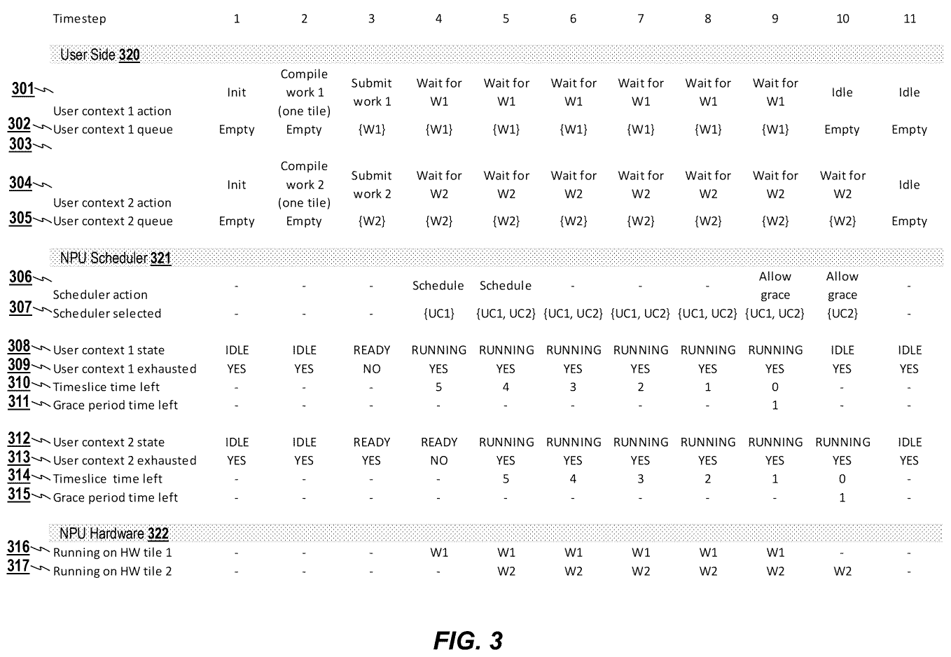

FIG. 3 illustrates an example indicating the timing of operations performed on the user side 320 (e.g., in applications 261-263), the NPU scheduler 321, and the NPU hardware 322 with two user contexts (context 1 and context 2). Each column corresponds to a different timestep, with time increasing to the right, and each row 301-317 corresponds to a particular operation. In this example, users compile work for execution on one NPU tile and the scheduler 240 schedules more work to fill the under-utilized NPU tiles when possible.

For example, in row 301, time t=2, work1 (W1) is compiled for execution on one tile by user context 1. The work is submitted to a work queue at time t=3. At row 306, time t=4, the NPU scheduler schedules the work for execution by the NPU tile, which begins processing the work (W1) at row 316, time t=4.

In this example, at time t=4, the scheduling algorithm recognizes that the selected context is exhausted, as indicated in row 309, meaning that it has no more runnable work, and that there are hardware resources available to potentially schedule more work. Thus, at time t=5, the scheduling algorithm selects work2 (W2) submitted by context 2 to run concurrently with W1 from context 1. Thus, at time t=5, NPU tiles 1 and 2 execute W1 and W2, respectively (as indicated in rows 316-317, at column t=5).

In some implementations, certain events will trigger the NPU scheduler to reevaluate the current state and determine whether scheduling or preemption is needed or possible. Referring to FIG. 2, a doorbell 260 may be implemented, which is a mechanism used by the host CPU 210 to indicate that one of the applications with an NPU context 261-263 has submitted new work to a corresponding work queue. In some implementations, the doorbell 260 is a defined region in memory 212 or a register (in the host CPU 210 or NPU scheduling hardware 230) which the scheduler 240 periodically reads to determine when new work is available.

The NPU scheduler may reevaluate the current state for subsequent scheduling in response to the completion of existing work and whether that work was completed or preempted. Scheduling decisions may also be reevaluated in response to a work queue being exhausted (i.e., all work has been processed from the selected queue), where it is known that there are still resources available to run additional work on the quantum expiry of a running context (i.e., where the quantum of processing time for a given context has expired).

In some implementations, when there is no running work, or the selected queue is exhausted (no more jobs in the queue), and there are resources available to run more work, then the scheduler 240 may select the next highest priority NPU work to be executed. The next highest priority work may be of equal or lower priority than the running work (in case of running work).

When new work arrives while there is already running work, if the running work is of lower priority than the new work, then the running work may be preempted in favor of the new work. If the running work is of equal priority, then the new work may be executed in parallel with the running work. If the running work is of higher priority, then the new work may be scheduled and executed in parallel with the running work, as long as the priority of the new work does not preclude it from being scheduled in parallel with other work. For example, if the new work has an “idle” priority, it will not be scheduled to prevent the idle priority work consuming memory bandwidth or any other shared resources of the NPU that might impact the completion of the higher priority work.

Implementations of this disclosure perform error tracking based on whether a single context or multiple contexts being processed by the NPU, as summarized in Table B below.

TABLE B

| Non-concurrent | Concurrent |
|---|---|
| Single context's progress | Multiple context's progress is tracked |
| is tracked | |
| Preemption is handled at | Preemption must target specific tiles |
| whole hardware level | |
| Reset operation resets | Reset operation may target specific tiles |
| all tiles | or all tiles |

When contexts are running in parallel, the implementations described herein ensure that a faulty context does not impact other contexts. Consequently, in these implementations, the scheduler 240 tracks each context's progress and errors individually. Preemption and context switch operations are performed on a per-NPU tile basis, rather than for all NPU tiles 251-254. In some implementations, when an error occurs in a particular NPU tile, the scheduler 240 terminates scheduling of further work on that tile until a hardware reset of the tile is performed. In some embodiments, any one of the NPU tiles 251-254 is capable of being individually reset without affecting operation of the other NPU tiles.

In some implementations, a reset may be performed for all tiles, as long as the scheduler 240 can track which tiles and contexts generated errors, and which contexts can be resumed after the reset. The scheduler 240 may cause the context state to be saved for contexts which have not generated an error before performing a reset of the corresponding NPU tiles. Following the reset, the saved state is restored to the corresponding NPU tiles so that processing of the context can resume.

In some implementations, the scheduler 240 tracks the status and progress of the individual NPU workloads corresponding to each context, including the errors generated per workload. The scheduler can then attribute errors to the context(s) which generated them. The scheduler 240 may also accumulate the time across which the context failed to complete any work.

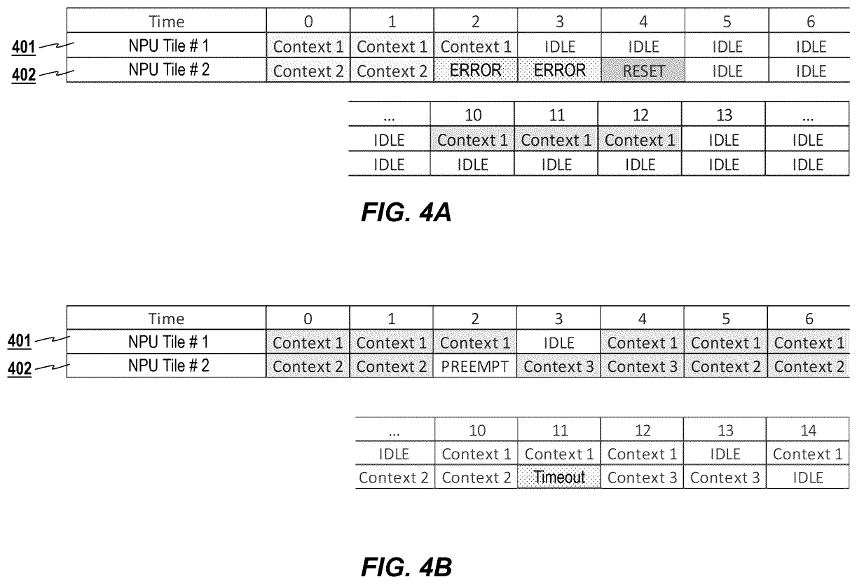

FIGS. 4A-B illustrate an example of status information tracked by the scheduler for contexts executed on two NPU tiles (labeled NPU Tile #1 and NPU Tile #2). A first row 401 of the table corresponds to NPU Tile #1 and a second row 402 corresponds to NPU Tile #2. Each column corresponds to a particular point in time, with time increasing incrementally from left to right.

In FIG. 4A, NPU Tile #1 is running Context 1 and NPU Tile #2 is running Context 2. While context 1 is running normally, Context 2 generates error conditions at times t=2 and t=3 which are detected by the scheduler 240. Context 2 is therefore marked as being in error, generating a notification to the host CPU 210 which requests a reset of Tile #2 at time t=4. In parallel, Context 1 continues to be processed, unaffected by the error on Tile #2. In this implementation, no further work is scheduled on Tile #2 until it is reset.

FIG. 4B illustrates an example of per-context timeout tracking for three contexts, Context 1, Context 2, and Context 3, executed on NPU Tiles #1 and #2 as indicated in rows 401 and 402, respectively. Context 1 consumes NPU Tile #1, which runs successfully. On NPU Tile #2, Context 2 runs overall for six time units, across multiple scheduling iterations. In particular, Context 2 runs first for two time units at time t=0 and t=2. At time t=3, Context 2 is preempted to free the execution resources of NPU Tile #2 for context 3, which runs for two time units, t=3 and t=4. Context 2 is scheduled again following the execution of Context 3, running from t=5 to t=10.

In this example, scheduler has set a timeout value of 6 for non-progress of work, so context 2 is timed out at t=11, and Context 3 is executed in time periods t=12-13. Work is stopped and no more work for Context 2 will be scheduled because it exceeded its timeout threshold (indicating a potential issue with the NPU tile). The host CPU is notified, and at some point, will request a reset of NPU tile #2. Consequently, no other running contexts are impacted.

In addition to the overall workload completion tracking as described above, some implementations report interim progress, including timeout indications, at a much shorter period. Thus, in this configuration, the non-progressing work can be terminated even earlier.

### Per-Tile Resource Scaling for Improved Performance and Power Consumption

If all NPU tiles are designed to operate at the same frequency, this can result in lower priority work being executed at the higher frequency configured for higher priority work (e.g., when the lower priority work is executed in parallel with the higher priority work). This result may be counter to the expectations of the user who expected a lower power impact for the lower priority work. In some instances, the lower priority work may even compete with and reduce the performance of the higher priority work because it competes for shared SoC resources.

To address these limitations, embodiments of the power management subsystem perform frequency scaling at the granularity of an NPU tile. In these implementations, the power management subsystem separately and independently controls the frequency of each NPU tile based on the type of workload being executed by the NPU tile, the priority of the workload, and/or the power and thermal limits of the SoC.

In some implementations, the maximum frequency is applied only for the NPU tiles on which the highest priority work is running. Based on the power management configuration, the power management subsystem may configure a lower frequency on any NPU tiles executing lower priority work in parallel (or in isolation) with the highest priority work.

Additionally, to safely run workloads having different priorities in parallel, the power management subsystem may apply quality-of-service labels to data requests in the wider SoC (e.g., memory access requests and responses transmitted via the SoC interconnect fabric). By providing more granular control of frequency, power consumption can be reduced further, and by applying priorities to shared resources, the higher priority work can be executed at higher performance and with reduced latency.

In some implementations, the power management subsystem which controls the frequency and voltage of the NPU 250 operates at a global level (e.g., across the SoC and the computer system). Processors, including central processing units (CPUs) and NPU tiles, as described herein, may leverage power management techniques that may be independent of and/or complementary to an operating system (OS)-based power management (OSPM) mechanism. According to one example OSPM technique, a the circuit blocks of an SoC processor can operate at various performance states or levels, typically referred to as P-states with respect to the host CPU cores or D-states with respect to other SoC circuit blocks. In general, the P1/D1 performance states may correspond to the highest guaranteed performance state that can be requested by an OS. In addition to the P1/D1 states, the OS can further request a higher performance state, namely P0/D0 states, if possible, given the SoC power budget.

Different types of power management techniques may be used individually or in combination with various embodiments described herein. In some implementations, a power controller may control the processor cores and other circuit blocks with dynamic voltage frequency scaling (DVFS), where an operating voltage and/or operating frequency of an SoC circuit block (such as an NPU tile) is dynamically controlled to reduce power consumption in certain situations.

Another exemplary power management technique is hardware duty cycling (HDC), which may cause SoC circuit blocks to be periodically enabled and disabled according to a duty cycle, such that one or more circuit blocks may be made inactive during an inactive period of the duty cycle and made active during an active period of the duty cycle.

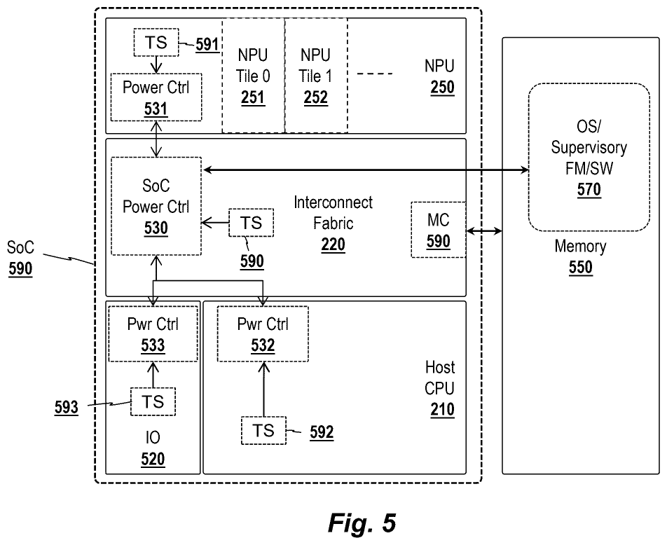

FIG. 5 illustrates an example system-on-chip (SoC) 590 comprising an interconnect fabric 220, a host CPU 210, an NPU 250, and IO circuitry 520 integrated on an integrated circuit (IC) chip, across multiple chips of a multi-chip package, or across multiple components of a computer system. The SoC 510 includes a memory controller 590 to couple the various SoC circuit blocks to system memory 550.

In some embodiments, the SoC 510 implements a distributed power management subsystem comprising a plurality of power control circuits (sometimes called “P-units”) 530-533 distributed across the various SoC circuit blocks (e.g., the host CPU 210, NPU 250, IO circuitry 520, etc.) In certain implementations, the power control circuits 530-533 are configured to operate together as a hierarchical power management subsystem in which a single supervisory power control circuit 530 makes SoC-wide power management decisions regarding power/performance states at which each of the individual circuit blocks are to operate (e.g., the frequencies and voltages for each of the circuit blocks, including the NPU 250). The power control circuit 530 may collect power-related telemetry data from the other power control circuits 531-533, which can include (but is not limited to) temperatures, power consumption levels, utilization levels, frequencies, and voltages of the various other circuit blocks 210, 220, 250, 520 and evaluate the telemetry data to implement the SoC-wide power control functions.

In these embodiments, the supervisory power control circuit 530 may send control messages to the other power control circuits 531-533 which responsively implement power-related functions indicated in the control messages (e.g., adjusting frequency/voltage levels). For example, the supervisor power control circuit 530 may communicate different power and/or performance states to the other power control circuits 531-533, which implement the power and/or performance states locally, on each respective circuit block (e.g., reducing or increasing the frequency of the NPU tiles 251-252 and/or cores of the host CPU 210).

An operating system (OS) and/or other supervisory firmware (FW) or software (SW) 570 may communicate with the supervisory power control circuit 530 to exchange power management state information and power management requests. In some implementations described herein, the communication between the OS/supervisory FW/SW 570 and the power control circuit 530 occurs via one or more mailbox registers. In some embodiments, a Baseboard Management Controller (BMC) or other system controller may exchange power control messages with the supervisory power control circuit 530 via these mailbox registers or a different set of mailbox registers.

In some embodiments, the thermal state of each circuit block is evaluated when making power management decisions. In FIG. 5, for example, temperature sensors 590-593 report temperature measurements to a corresponding local power control circuit 530-533, which may dynamically adjust local power consumption based on the temperature measurements and/or pass the temperature measurements to the supervisor power control circuit 530 which incorporates the temperature measurements into its SoC-wide power management decisions. In the illustrated example, temperature sensor 591 reports temperatures associated with the NPU 250 to local power control circuitry 531 and a temperature sensor 590 associated with the fabric interconnect 220 reports temperature measurements directly to the supervisor power control circuit 530.

### Per-Tile Clock Frequency Configurations

In current implementations, the NPU makes frequency requests to the power control subsystem 530-533 based on workloads and current conditions and a single frequency is supplied to the entire NPU based on the power and performance management policy.

In some implementations of this disclosure, the same frequency requests are made to the SoC power control unit, but the local NPU power control logic (e.g., implemented in NPU firmware) is configured to scale the incoming frequency to each NPU tile depending on characteristics of the work running on each NPU tile and the overall system conditions.

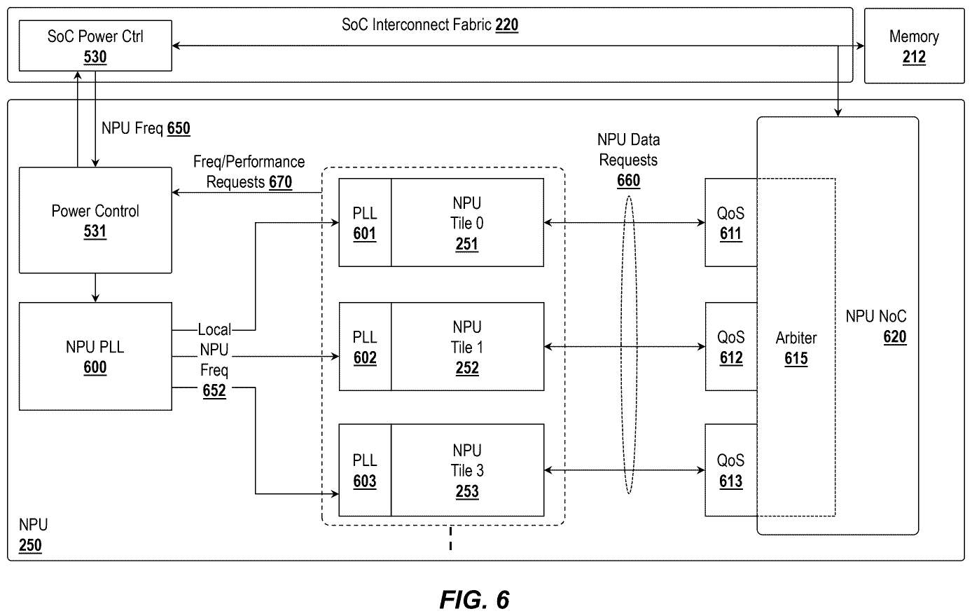

FIG. 6 illustrates an example implementation in which the SoC power control circuitry 530 (e.g., the supervisor P-unit) authorizes a system-level NPU frequency 650 in response to aggregated NPU data requests 660 transmitted over the NPU interconnect fabric 220. Explicit frequency/performance requests 670 may be transmitted to the local power control circuit 531, which may responsively transmit a frequency/performance request 650 for a particular frequency or performance state to the SoC power control circuit 530.

The SoC power control circuit 530 determines whether to grant the frequency/performance request 650 based on frequency/performance requests and telemetry data received from all of the power control circuits 531-533, and in view of the power and thermal limitations of the SoC. The SoC power control circuit 530 provides an indication of the NPU frequency 650 via the local power control circuitry 531. In response, the local power control circuitry 531 controls a primary phase locked loop (PLL) of the NPU to generate clock signals at a local NPU frequency 652 to PLLs 601-603 of the individual NPU tiles 251-253.

In contrast to implementations in which each NPU tile 251-253 operates at the same frequency, each of the per-tile PLLs 601-603 is configured to scale or pass through the NPU frequency 650 in accordance with the workloads being executed. For example, if NPU tile 252 is executing a context assigned an idle priority, then its PLL 602 may scale down the local NPU frequency 652 or clock-gate the NPU tile 252. Conversely, if NPU tile 251 is executing a context at an absolute realtime priority, then PLL 601 may pass through or scale up the local NPU frequency 650 to a higher frequency to complete the high priority workload. However, in an implementation in which the NPU frequency 652 is the maximum allowable frequency, the PLLs 601-603 can either provide a bypass of the clock signal (i.e., output clock=input clock) (e.g., for higher priority workloads) or scale down the frequency (e.g., for lower priority workloads). If all contexts are being executed at a common priority, then the per-tile PLLs may all enter into the bypass mode and run the corresponding NPU tiles 251-253 at the same frequency.

### QoS Configuration

In some embodiments, the NPU 250 processes each workload in accordance with a corresponding Quality of Service (QoS) level. Thus, as indicated in FIG. 6, NPU data requests 660 generated by the plurality of NPU tiles 251-253 may each be associated with a Qos classification 611-613. The NPU network-on-chip (NoC) 620 which couples the NPU tiles 251-253 to the SoC interconnect fabric 220 and memory 212 includes an arbiter 615 to arbitrate access to the NPU NoC 620, memory 212, and interconnect fabric 220 in accordance with each specified QoS level 611-613.

In some implementations, the QoS for each data request 660 is indicated via sideband signals, passed along with the address of the data request and any other metadata associated with the data transaction. In configurations where a separate priority level is assigned to each NPU tile (e.g., based on the priority of the corresponding workload), the arbiter 615 may associate a QoS level with each respective priority level (or treat the priority level as the QoS level), thereby limiting competition between higher and lower priority work. If there is no competition, then the QoS indications 611-613 have no impact. The number of priority levels can match the number of priorities supported—e.g., Idle, normal, focus, and realtime in some embodiments. The arbiter 615 in these embodiments does not completely throttle the lower/lowest priority work but it is expected that the lower/lowest priority work will be allocated a reduced throughput in the NoC 620 to access memory 212 compared with higher priority work. When running at a high utilization, each drop in priority may translate to a drop in NoC throughput.

By way of example, and not limitation, assume that high priority work and low priority work are being executed concurrently on the NPU 250. Frequency requests 670 will continue to be sent to the SoC power control circuit 530 in accordance with the deadline requirements of the highest priority work and the resource requirements of the high priority work allow lower priority work to be executed in parallel. In this case, the lower priority work would benefit from a higher-than-normal frequency. The frequency of the NPU tile 251-253 on which the lower priority work runs may therefore be scaled down by its corresponding PLL 601-603 to the frequency at which it would run if executed alone.

TABLE C

| Parameter | Max frequency |
|---|---|
| Lower priority band min frequency | NPU min frequency |
| Lower priority band max frequency | NPU medium frequency |
| Lower priority application target frequency | NPU medium frequency |
| High priority band min frequency | NPU medium frequency |
| High priority band max frequency | NPU max frequency |
| High priority application target frequency | NPU max frequency |

Table C indicates how an example set of parameter data maps to NPU tile frequencies, in accordance with some embodiments. The NPU tile frequencies include a minimum frequency, a maximum frequency, and a medium frequency. The dynamic voltage and frequency scaling (DVFS) implementation enabled by the PLLs 601-603 targets the maximum NPU tile frequency for the high priority work to hit its deadline, and that frequency will be supplied via the PLLs 601-603 to the tile(s) running the high priority work. However, because the lower priority work does not have a strict deadline requirement, the NPU tile running the lower priority work will be set to the medium frequency at most, thereby reducing power consumption.

When the NPU is configured for QoS levels, and both the low priority work and high priority work have a high memory access rate, then the memory throughput for the lower priority work can be throttled relative to the higher priority work. For example, the higher priority work may be assigned the QoS priority of 4 (maximum throughput for an absolute realtime priority level), and the lower priority application may be assigned the QoS priority of 2 (normal priority for a normal priority level). Consequently, the impact of running the lower priority work in parallel with the higher priority work is reduced.

### Power Efficient Cross-Device Signaling

Some implementations of this disclosure support power efficient and low latency exchanges of work between the NPU and other SoC circuit blocks, such as the GPU, which may be integrated in the SoC or coupled to the SoC via a PCIe interconnect (or other type of interconnect).

In existing implementations, an application must include a fence signal in the relevant queue for the GPU, and include a fence wait in the relevant queue for the NPU. When the output buffer from GPU is ready to be used as input in NPU, a signal is passed from the GPU to the GPU driver, then to the OS, then to the NPU driver, and then to the NPU, incurring a full roundtrip through the CPU to initiate the work on the NPU.

To address these limitations, some implementations of this disclosure allow the GPU to write a value to a shared memory location which the NPU polls. When the value is greater than or equal to a defined control threshold, the NPU begins processing the work. These implementations may leverage PCIe peer-to-peer communication; the GPU host driver submits a direct memory access (DMA) packet in the GPU batch buffer. When the output buffer is ready, a DMA operation is executed in accordance with the DMA packet, writing a register in the NPU and causing the NPU to wake and determine whether any work can be processed. The OS does not need to be involved in these operations, and no memory access is incurred. This sequence can also be used to support NPU-to-GPU signaling.

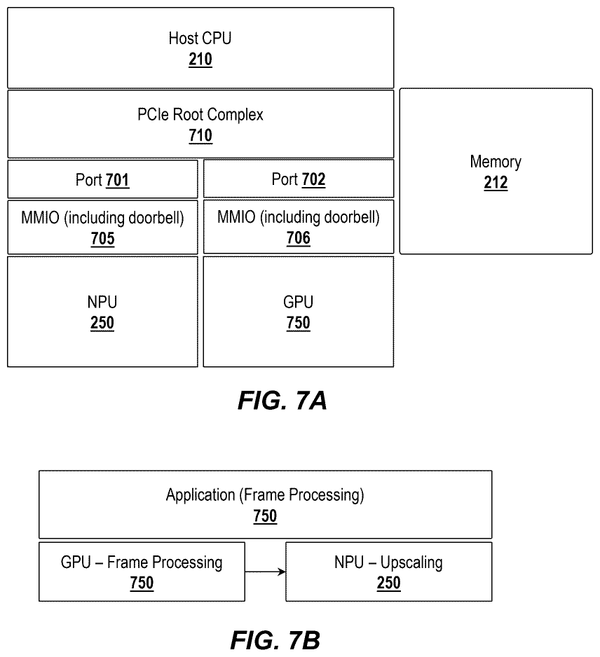

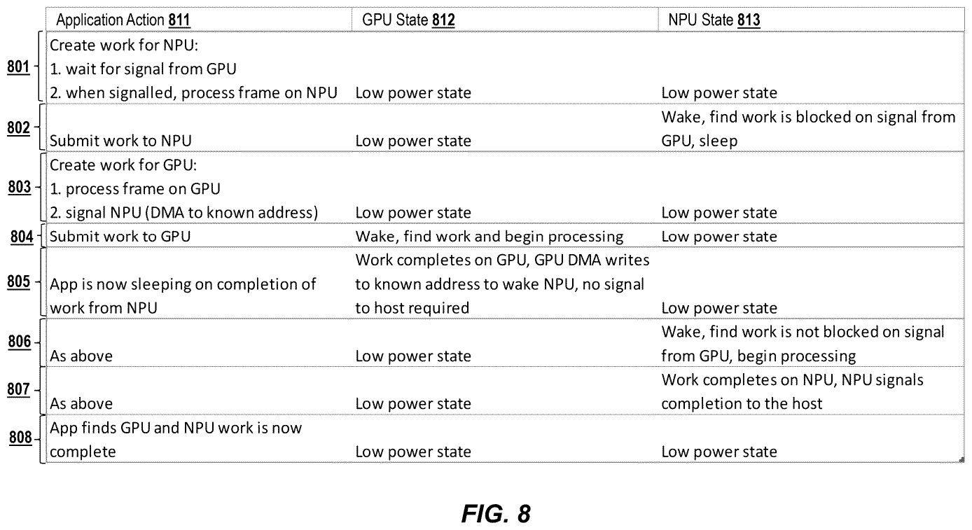

FIG. 7A illustrates an example SoC configuration including a host CPU 210 with a corresponding PCIe root complex 710 coupled to an NPU 250 and a GPU 750. In these implementations, the system software indicates to the GPU driver the relevant PCIe target information to communicate with the NPU and indicates to the NPU driver the relevant PCIe target information to communicate with the GPU. For example, the PCIe target information indicated to the GPU may include an indication of an MMIO region 705, root complex port 701, and an address to write to trigger the NPU 250 to wake (doorbell) and the PCIe target information indicated to the NPU comprises an indication of an MMIO area 706, root complex port 702, and the address to write to trigger the GPU 750 to wake (doorbell).

For an application that has work to be performed which requires both the GPU 750 and the NPU 250, these embodiments enable a low latency flow. FIG. 7B illustrates one example in which application 750 requires different frame processing operations to be performed by the GPU 750 and the NPU 250. The GPU 750 is used initially to generate a frame. When complete, the GPU 750 uses the signaling described herein to notify/wake the NPU 250 (e.g., writing to the MMIO region 705 which is polled by the NPU). The NPU 250 reads the notification/wake indication and responsively performs upscaling operations on the frame.

FIG. 8 illustrates an example in which different actions taken by an application, described in rows 801-808 of the first column 811, are mapped to a corresponding GPU state, indicated in the second column 812, and NPU state, indicated in the third column 813. As indicated in row 801, work is created for the NPU comprising (1) waiting for a signal from the GPU, and (2) when signaled, processing a frame. Both the NPU and GPU may be in a low power state at this stage. Because the NPU will only execute work upon receiving a signal from the GPU (e.g., a write to an MMIO region), at row 802, in response to work submitted for processing by the NPU, the NPU wakes, determines that the GPU signal has not been received, and returns to a sleep state.

In row 803, work is created for the GPU comprising: (1) processing a frame, and (2) signaling to the NPU (e.g., via DMA to a known MMIO address). Both the GPU and NPU are in a low power state at this stage. In row 804, the work is submitted to the GPU, which wakes, identifies the work and begins processing. In row 805, while the application is sleeping, the GPU completes the work and generates a DMA writes to the MMIO address to wake the NPU.

At 806, the application continues to sleep while the NPU wakes, determines that work is not blocked based on the signal from the GPU, and begins processing. At 807, the application remains sleeping while work completes on the NPU, which signals its completion to the host CPU. At 808, the application wakes to find that the GPU and NPU work is complete.

Efficient Work Scheduling with Estimated Context Deadlines

GPUs and NPUs may process arbitrary submission patterns from users at varying priority levels. In current implementations, schedulers manage scheduling of the work in accordance with priority-based preemption, leading to higher power consumption and reduced performance due to preemption in circumstances when it is not needed to satisfy the application's requirements.

Some implementations of this disclosure resolve these drawbacks by estimating context deadlines for high priority work and choosing not to preempt the low priority work if the context deadlines can be met. For example, the NPU scheduler 240 may derive the periods of workload submissions on a per-context basis, when one type of work is submitted per context. The NPU scheduler 240 may also determine the actual hardware cycle count of a given workload and can then estimate a deadline for the workload based on this information.

Using the estimated deadline, the scheduler can make more informed decisions regarding whether preempting work of a lower priority workload is necessary. Completing the lower priority work without preemption while still meeting the deadline of the higher priority work results in reduced power consumption and improved performance. For example, the costs associated with preempting the lower priority work is avoided, including (a) the time spent preempting the lower priority work, (b) context switching the hardware to the new context, (c) context switching the hardware back to the original context, and (d) resuming the lower priority work.

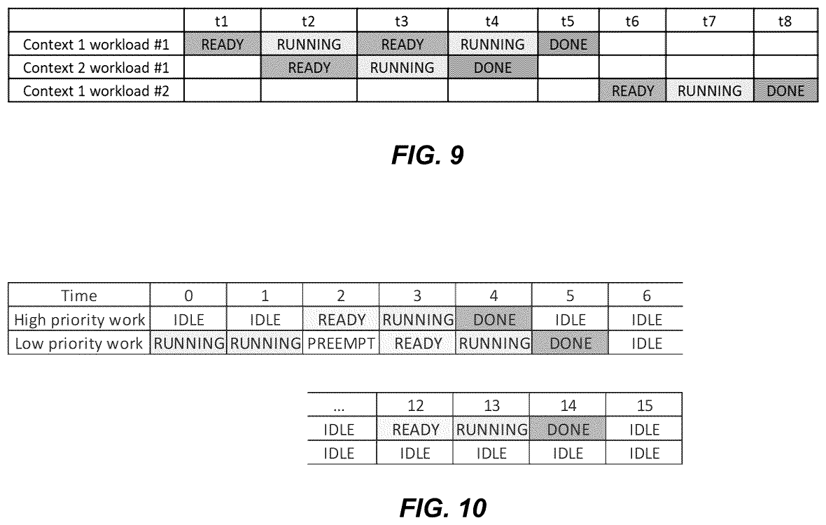

For each context managed by the scheduling firmware, if only one type of work is submitted, then the scheduler 240 can estimate the deadline for the work on that context as per the example illustrated in FIG. 9. In this example, the NPU workload arrival period for context 1 is defined as: context_period=t6−t1. The NPU workload execution time for context 1 is the time period when the NPU was actively running: context_exec_time=t2+t4. From this information, the scheduler can estimate that the context deadline for context 1 is t6. Note that it may take the scheduler a number of iterations to estimate the period and execution time of context 1's work, within some standard deviation.

The scheduler 240 does not receive any explicit information about the types of pre-processing and post-processing that are required on the NPU 250. For any given context, there is an unknown pre-processing time required to make the work ready for processing on the NPU, and there is an unknown time required to complete some overall operation after the NPU processing is complete.

TABLE D

| Time | Context event | Frame scope |
|---|---|---|
| t1 | Frame input | Frame 1 start |
| t2 | Frame pre-processing | |
| t3 | NPU work | |
| t4 | Frame post-processing | Frame 1 end |
| t5 | IDLE time | |
| t6 | Frame input | Frame 2 start |
| t7 | Frame pre-processing | |
| t8 | NPU work | |
| t9 | Frame post-processing | Frame 2 end |
| t10 | IDLE time | . . . |

Referring to the example in Table D, if NPU work completes later than expected, then it has an unknown impact on frame post-processing and the subsequent frame pre-processing operations. In the worst case scenario, all work for this context may execute on a single thread on the host CPU.

One example of runtime deadline estimation will be described with respect to FIG. 10, which shows a table with a first row indicating the state of a high priority workload at increasing points in times and a second row indicating the state of a low priority workload at the same points in time.

The fixed cost of preemption (preemption_cost) is 1. The high priority Context_period=10, the high priority Context_exec_time=1, the low priority Context_period=20, and the low priority Context_exec_time=3. The grace period, i.e., the time which the low priority workload is allowed to continue execution before preemption from low to high priority work=low_to_high_grace_period=0.

In the illustrated example, the high priority workload caused preemption of the low priority workload at time t=2. The high priority workload started running at t=3 and completed in 1 unit of time, releasing the resources back to the low priority work, which also completes in 1 unit of time (i.e., executes at t=4 and is completed at t=5).

At the extreme, in order to meet the known deadline of context_period (10), the high priority work could have been delayed in execution until t=10, although this could impact CPU-side pre- and post-processing.

In some implementations, the scheduler 240 applies a grace period to lower priority work to potentially allow completion of the lower priority work while minimizing the delay in execution of the high priority work. For example, a grace period may be selected such that the high priority workload will complete no later than some percentage of its normal period (e.g., ⅓ longer). In these implementations, the grace period may be determined and stored as a fixed constant in the scheduler 240.

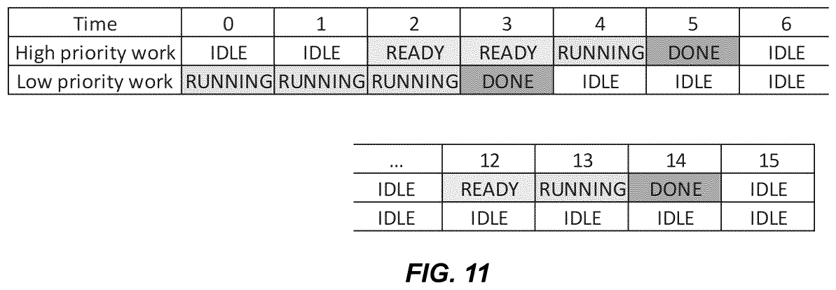

Another example is described with respect to FIG. 11. In this example, assume the fixed cost of preemption (preemption_cost)=1, the high priority Context_period=10, the High priority Context_exec_time=1, the low priority Context_period=20, the low priority Context_exec_time=3, and the maximum deadline-related grace period (scheduler_max_deadline_related_grace_period)=3.

Using the above information, the grace period of preemption from low to high priority work (low_to_high_grace_period) is the minimum of:

$$( high priority context\_period / 3 ) - high\_priority \_exec \_time - preemption\_cost$$

$$and$$

$$scheduler\_max \_deadline \_related \_grace \_period .$$

Plugging in values from the example generates a grace period of 1.33:

$$Min ( ( 10 / 3 ) - 1 - 1 , 3 ) = Min ( 1.33 , 3 ) = 1.33 .$$

In accordance with this implementation, at t=2 in FIG. 11, the scheduler 240 deferred preemption of the low priority work by applying a grace period of 1.33. As a result, the low priority work was able to complete in one more unit of time (by t=3) and both workloads completed inside their deadlines without preemption.

In some embodiments, the scheduler 240 monitors execution through multiple iterations. If the Context_period or Context_exec_time become inconsistent or unstable, the scheduler 240 stops using them and does not apply a deadline-related grace period until the measurements stabilize again. This can mean that the estimations of the context period or execution time were inaccurate, or that the grace period application is having a negative impact on the context's overall performance. In some implementations, if this kind of instability occurs more than N times in the lifetime of the context (e.g., where N=2, 3, 4, etc.), then the scheduler 240 determines that it cannot apply the deadline-related grace period to this context.

When the scheduler 240 schedules a particular workload, it is aware of the required hardware cycle count of the given workload, specified as context_exec_time. In addition, a general preemption target is defined as the maximum time expected to be required to complete a preemption for a given workload, specified as preemption_cost. When a workload is evaluated for preemption, the scheduler is aware of the time progressed so far, specified as work_intermediate_progress_time.

Using the above definitions, the scheduler 240 can determine the remaining time for a workload using: remaining_work_time=context_exec_time-work_intermediate_progress_time.

The scheduler 240 can then determine whether it will attempt to avoid preemption of the workload with:

If remaining_work_time <= preemption_cost then skip
preemption and allow the workload to complete.

The scheduler 240 may operate in accordance with a margin, for example, preemption_cost+/−10%. In these implementations, when the scheduler 240 is attempting to avoid preemption, it starts a grace period timer. If the workload is not completed when the timer reaches the specified grace period, the workload is preempted.

### Optimal Scheduling of Workloads Given Multiple Compilation Options

In existing implementations, workloads are scheduled on an NPU using fixed resources. A scheduler may often choose the maximum available resources without considering other options which would meet the performance requirements (e.g., specified deadlines) while conserving power. In addition, as discussed above, schedulers in current implementations automatically preempt lower priority workloads in favor of higher priority workloads, even in cases where preemption is not necessary to satisfy the higher priority workload's performance requirements.

Some embodiments of this disclosure address these limitations by providing options in a work request (e.g., dynamically generated using an NPU compiler) to allocate a different number of NPU tiles to execute a workload. In some embodiments, the NPU scheduler 240 evaluates the expected runtime and estimated power efficiency of a workload when executed on different numbers of NPU tiles, and uses this information to choose a particular option at runtime which satisfies the workload's execution requirements while conserving power. The options may be provided via a runtime compiler controlled by the NPU scheduler 240, although the underlying principles of this disclosure are not limited to this particular implementation.

In some implementations, for each workload to be run on the NPU 250, the scheduler 240 can evaluate different NPU tile/resource counts (work_tile_count) and corresponding estimated time to completion (work_total_time) for each workload. In the following example, the scheduler allows equal priority workloads to run concurrently and selects each workload of a given context in view of the other workloads of equal priority which are also ready to run. If the work_total_time of the highest NPU tile count is inside a certain margin of the work_total_time of another, lower NPU tile count (e.g., completing 20% faster), then the scheduler may choose the lower tile count, prioritizing concurrency on the hardware over maximum throughput of a single workload.

TABLE E

| Workload | Parameters | Option 1 | Option 2 |
|---|---|---|---|
| Workload | workload_tile_count | 1 | 3 |
| 1 | workload_total_time | 10 | 8 |
| Workload | workload_tile_count | 1 | 3 |
| 2 | workload_total_time | 10 | 8 |
| Workload | workload_tile_count | 1 | 3 |
| 3 | workload_total_time | 10 | 8 |

Table E illustrates an example with two options associated with three workloads of equal priority. In some implementations, these options are provided by the NPU compiler which may dynamically compile the NPU workload for execution in accordance with the selected option. In this example, with a tile count of 1, Workload 1 would complete in 10 units of time (Option 1) and with a tile count of 3, Workload 1 would complete in 8 units of time (Option 2), which is only 20% faster while consuming 3× the resources. Because Option 2 would be an inefficient use of the processing resources, Option 1 is selected. There are two similar workloads (2 and 3) which the scheduler may choose to schedule in parallel, resulting in: workload 1 option 1, workload 2 option 1 and workload 3 option 1.

The technique of choosing a lower NPU tile count when the work_total_time of the highest NPU tile count is inside a certain margin of the work_total_time of a lower NPU tile count balances between performance and power savings.

The example below makes maximizes hardware utilization across priorities. For example, the scheduler 240 may choose the most efficient option for the chosen group of workloads. When the most efficient option still leaves a hardware resource (e.g., NPU tile) available for other workloads, the scheduler may choose a less efficient option for a lower priority workload to allow it to progress, potentially without any preemption.

TABLE F

| Workload | Parameters | Option 1 | Option 2 |
|---|---|---|---|
| High priority | workload_tile_count | 1 | 2 |
| Workload 1 | workload_total_time | 10 | 5 |
| Lower priority | workload_tile_count | 1 | 3 |
| Workload 2 | workload_total_time | 15 | 5 |

Table F provides an example with two options for workload tile counts for a high priority workload 1 and a lower priority workload 2. The highest NPU tile count option for workload 1 is option 2, with two NPU tiles, which is efficient and cuts the total execution time of the workload in half. One NPU tile remains, so the scheduler 240 identifies a lower priority workload 2 to fit in this slot without preemption. Thus, workload 1 option 2 and workload 2 option 1 are scheduled in parallel on respective NPU tiles.

As another example, the scheduler 240 may attempt to map workloads to NPU tiles in the most power-efficient manner possible. For example, the NPU tile may choose a relatively lower workload tile count for a high priority workload if the highest tile count option is inefficient. Figure G illustrates an example in which a high priority workload 1 runs only 10% faster on three NPU tiles compared to two NPU tiles, which would consume 33% less power. The scheduler 240 will therefore select Option 1 to conserve power, as long as the requirements of the deadline requirements of the high priority workload can still be met. More generally, when the scheduler 240 chooses NPU tiles for a workload in view of power efficiency, it may select the option with the fewest tiles which still meets the performance requirements of the workload.

TABLE G

| Workload | Parameters | Option 1 | Option 2 |
|---|---|---|---|
| High priority Workload | workload_tile_count | 2 | 3 |
| 1 | workload_total_time | 10 | 9 |

There may be cases where the above techniques are counterproductive. In these cases, an override can be generated to allow time-critical workloads to specify their exact execution requirements without any intervention. The override may be generated by the operating system or system software or firmware which is not generally available to the user.

In some implementations, the user contexts and option selections/compilations occur in user space, while the final scheduling and work execution occurs in a trusted execution environment (e.g., a trusted enclave, such as a trusted virtual machine). If the data has been tampered with to have the scheduler 240 favor a particular option, the worst outcome is an inefficient use of the context's execution time on the hardware, which should not negatively impact other contexts, except that the other contexts may never have a chance to share hardware with the misbehaving user context.

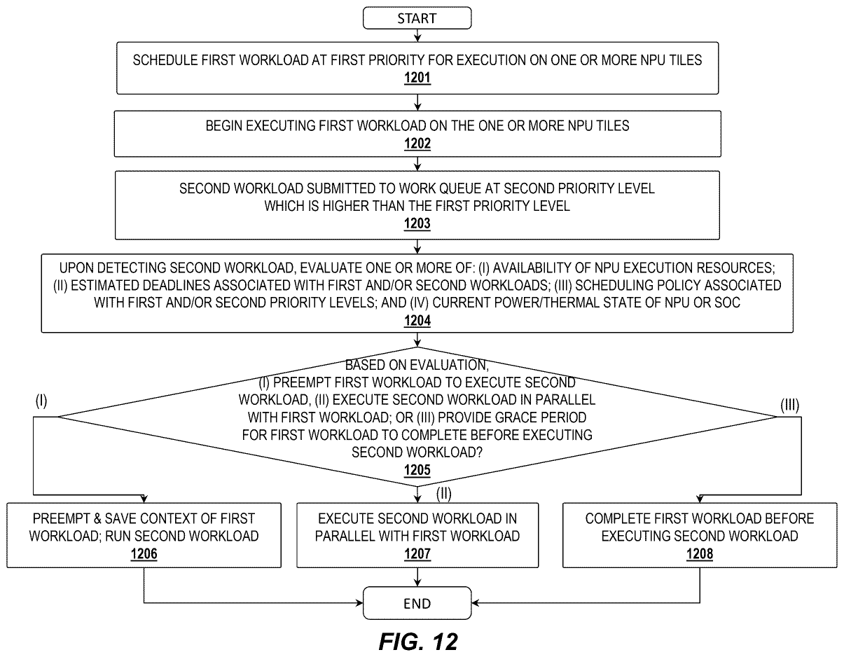

FIG. 12 illustrates a method for scheduling workloads in accordance with some embodiments of this disclosure. The method may be implemented on the architectures described herein, but is not limited to any particular NPU or system-level architecture.

At 1201, a first workload is scheduled for execution on one or more NPU tiles and, at 1202, the NPU tiles begin executing the first workload. At 1203, a second workload is submitted to a work queue at a second priority level which is higher than the first priority level.

At 1204, upon detecting the second workload, the scheduler evaluates one or more of: (i) the availability of NPU execution resources; (ii) the estimated deadlines associated with the first workload and/or the second workload; (iii) the scheduling policy associated with the first and/or second priority levels; and (iv) the current power/thermal state of the NPU or SoC.

At 1205, based on the evaluation, the scheduler may choose to (i) preempt the first workload to execute second workload, (ii) execute the second workload in parallel with the first workload; or (iii) provide a grace period for the first workload to complete before executing the second workload.

For example, in the simple case where one or more NPU tiles are idle and the NPU and SoC are operating within defined power and thermal limits, then the scheduler may schedule the second workload to execute on these NPU tiles in parallel with the first workload at 1207. If no additional NPU tiles are available, then the scheduler may determine whether to (i) preempt and save the context of the first workload to execute the second workload at 1206 or (iii) provide a grace period for the first workload to complete before executing the second workload at 1208.

As described above, to make this determination, the scheduler may estimate the context deadline for the second (higher priority) workload and provide a grace period to allow the first (lower priority) workload to complete while still allowing sufficient time for the second workload to meet its context deadline. As described above, the NPU scheduler may derive the periods of workload submissions on a per-context basis, when one type of work is submitted per context and/or may determine the actual hardware cycle count of a given workload and estimates a deadline for the workload based on this information. Thus, at 1205, using the estimated deadline and other variables, the scheduler can make more informed decisions regarding whether to preempt work of a lower priority workload in favor of a higher priority workload.

In some cases, the scheduler decision at 1205 is dictated by the scheduling policy associated with the first and second priority levels. For example, the scheduling policy may dictate that any workloads running at the first priority level are not to be executed in parallel with workloads at any other priority level (e.g., such as the “Idle” priority band described above). In this case, the scheduler may automatically preempt the first workload in favor of the second workload.

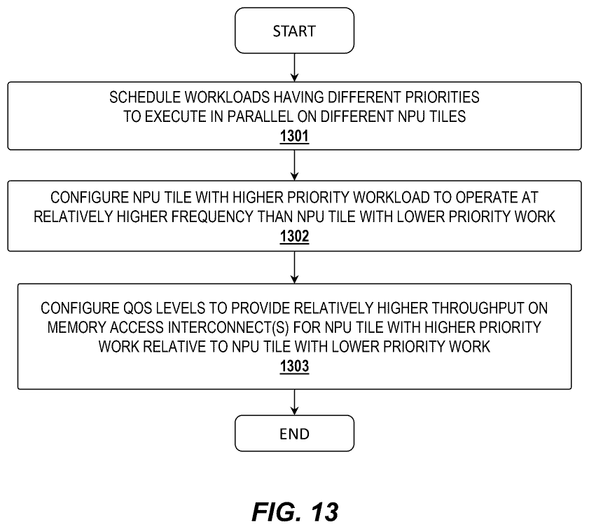

FIG. 13 illustrates a method in accordance with some embodiments of this disclosure in which additional resource allocations are performed based on Quality of Service (QoS) levels associated with different workloads. The method may be implemented on the architectures described herein, but is not limited to any particular NPU or system-level architecture.

At 1301, workloads having different priorities are scheduled to execute in parallel on different NPU tiles and, at 1302, NPU tiles executing higher priority workloads are configured to operate at relatively higher performance levels/frequencies than NPU tiles with lower priority workloads.

At 1303, Quality of Service (QoS) levels are assigned to the workloads to control the allocation of memory bandwidth. For example, relatively higher throughput may be allocated on memory access interconnects for NPU tiles running higher priority workloads relative to NPU tiles running relatively lower priority workloads.

### EXAMPLES

The following are example implementations of different embodiments of the invention.

Example 1. An apparatus comprising: a plurality of neural processing unit (NPU) tiles; a scheduler to schedule a plurality of workloads for execution on the plurality of NPU tiles, the scheduler to: schedule a first workload associated with a first priority for execution on at least a first NPU tile of the plurality of NPU tiles; and responsive to an indication of a second workload associated with a second priority which is higher than the first priority submitted for execution, determining whether to: preempt the first workload to execute the second workload on the first NPU tile, execute the second workload on a second NPU tile in parallel with the first workload, or provide a grace period for the first workload to complete execution before executing the second workload on the first NPU tile, the determining based, at least in part, on one or more of: (i) whether there are any idle NPU tiles in the plurality of NPU tiles; (ii) estimated deadlines associated with the first workload and/or the second workload; (iii) a scheduling policy associated with workloads executing at different priority levels; and (iv) current power or thermal conditions of the plurality of NPU tiles or a processor in which the plurality of NPU tiles are integrated.

Example 2. The apparatus of example 1, wherein based on an estimated deadline associated with the second workload, the scheduler is to provide a grace period for the first workload to complete execution on the first NPU tile before executing the second workload on the first NPU tile, the grace period having a duration selected to ensure that the estimated deadline associated with the second workload will be met.

Example 3. The apparatus of examples 1 or 2, wherein the scheduler is to preempt the first workload to execute the second workload on the first NPU tile when the first workload has not completed execution in accordance with the grace period.

Example 4. The apparatus of any of examples 1-3, wherein to preempt the first workload, the scheduler is to cause a first context state associated with the first workload to be saved to memory and/or persistent storage.

Example 5. The apparatus of any of examples 1-4, wherein following execution of the second workload, the scheduler is to resume execution of the first workload on the first NPU tile, the scheduler to cause the first context state to be restored to the first NPU tile from the memory and/or persistent storage.

Example 6. The apparatus of any of examples 1-5, wherein the indication of the second workload is to be provided to the scheduler in a doorbell register or memory location updated by a host processor to indicate the second workload.

Example 7. The apparatus of any of examples 1-6, wherein the first workload is associated with a first user context and the second workload is associated with a second user context, and wherein during execution of the first workload, the scheduler is to track a first context state corresponding to the first user context and during execution of the second workload, the scheduler is to track a second context state corresponding to the second user context.

Example 8. The apparatus of any of examples 1-7, wherein the scheduler is to perform per-user context timeout tracking comprising a first period of time or first number of execution cycles within which the first user context must complete execution and a second period of time or second number of execution cycles within which the second user context must complete execution.

Example 9. The apparatus of any of examples 1-8, wherein if the first user context fails to complete execution within the first period of time or first number of execution cycles, then the scheduler is to generate a notification to a host processor, which is to subsequently cause a reset of at least the first NPU tile.

Example 10. The apparatus of any of examples 1-9, wherein the first context state includes any errors generated during execution of the first workload and the second context state includes any errors generated during execution of the second workload.

Example 11. The apparatus of any of examples 1-10, wherein when the scheduling policy indicates that any workload executing at the first priority will not be scheduled in parallel with any other workload, then the scheduler is to preempt the first workload in favor of the second workload.

Example 12. The apparatus of any of examples 1-11, wherein if there is at least a second NPU tile which is idle and which is capable of executing the second workload in accordance with an estimated deadline associated with the second workload, then the scheduler is to schedule the second workload for execution on the second NPU tile, the second workload to be executed on the second NPU tile in parallel with the first workload being executed on the first NPU tile.

Example 13. The apparatus of any of examples 1-12, wherein the scheduler is to determine to not execute the second workload in parallel with the first workload and/or is to determine to reduce a frequency of one or more of the plurality of NPU tiles if the current power or thermal conditions of the plurality of NPU tiles indicate that a power threshold or temperature threshold is exceeded.

Example 14. A machine-readable medium having program code stored thereon which, when executed by one or more processors, is to cause the one or more processors to perform operations, comprising: scheduling, by a scheduler, a plurality of workloads for execution on a plurality of NPU tiles, wherein scheduling further comprises: scheduling a first workload associated with a first priority for execution on at least a first NPU tile of the plurality of NPU tiles; and determining, responsive to an indication of a second workload associated with a second priority which is higher than the first priority submitted for execution, whether to: preempt the first workload to execute the second workload on the first NPU tile, execute the second workload on a second NPU tile in parallel with the first workload, or provide a grace period for the first workload to complete execution before executing the second workload on the first NPU tile, the determining based, at least in part, on one or more of: (i) whether there are any idle NPU tiles in the plurality of NPU tiles; (ii) estimated deadlines associated with the first workload and/or the second workload; (iii) a scheduling policy associated with workloads executing at different priority levels; and (iv) current power or thermal conditions of the plurality of NPU tiles or a processor in which the plurality of NPU tiles are integrated.

Example 15. The machine-readable medium of example 14, wherein based on an estimated deadline associated with the second workload, providing, by the scheduler, a grace period for the first workload to complete execution on the first NPU tile before executing the second workload on the first NPU tile, the grace period having a duration selected to ensure that the estimated deadline associated with the second workload will be met.

Example 16. The machine-readable medium of examples 14 or 15, wherein the scheduler is to preempt the first workload to execute the second workload on the first NPU tile when the first workload has not completed execution in accordance with the grace period.

Example 17. The machine-readable medium of any of examples 14-16, wherein to preempt the first workload, the scheduler is to cause a first context state associated with the first workload to be saved to memory and/or persistent storage.

Example 18. The machine-readable medium of any of examples 14-17, wherein following execution of the second workload, the scheduler is to resume execution of the first workload on the first NPU tile, the scheduler to cause the first context state to be restored to the first NPU tile from the memory and/or persistent storage.

Example 19. The machine-readable medium of any of examples 14-18, wherein the indication of the second workload is to be provided to the scheduler in a doorbell register or memory location updated by a host processor to indicate the second workload.

Example 20. The machine-readable medium of any of examples 14-19, wherein the first workload is associated with a first user context and the second workload is associated with a second user context, and wherein during execution of the first workload, the scheduler is to track a first context state corresponding to the first user context and during execution of the second workload, the scheduler is to track a second context state corresponding to the second user context.

Example 21. The machine-readable medium of any of examples 14-20, wherein the scheduler is to perform per-user context timeout tracking comprising a first period of time or first number of execution cycles within which the first user context must complete execution and a second period of time or second number of execution cycles within which the second user context must complete execution.

Example 22. The machine-readable medium of any of examples 14-21, wherein if the first user context fails to complete execution within the first period of time or first number of execution cycles, then the scheduler is to generate a notification to a host processor, which is to subsequently cause a reset of at least the first NPU tile.

Example 23. The machine-readable medium of any of examples 14-22, wherein the first context state includes any errors generated during execution of the first workload and the second context state includes any errors generated during execution of the second workload.

Example 24. The machine-readable medium of any of examples 14-23, wherein when the scheduling policy indicates that any workload executing at the first priority will not be scheduled in parallel with any other workload, then the scheduler is to preempt the first workload in favor of the second workload.

Example 25. The machine-readable medium of any of examples 14-24, wherein if there is at least a second NPU tile which is idle and which is capable of executing the second workload in accordance with an estimated deadline associated with the second workload, then the scheduler is to schedule the second workload for execution on the second NPU tile, the second workload to be executed on the second NPU tile in parallel with the first workload being executed on the first NPU tile.

Example 26. The machine-readable medium of any of examples 14-25, wherein the scheduler is to determine to not execute the second workload in parallel with the first workload and/or is to determine to reduce a frequency of one or more of the plurality of NPU tiles if the current power or thermal conditions of the plurality of NPU tiles indicate that a power threshold or temperature threshold is exceeded.

Example 27. An apparatus comprising: a plurality of neural processing unit (NPU) tiles; a scheduler to determine a number of the NPU tiles on which to execute a first workload based on an evaluation of first execution metrics associated with the first workload, the first execution metrics to include an indication of an expected duration of time or cycles required to execute the first workload with different numbers of NPU tiles.

Example 28. The apparatus of example 27, wherein when the first execution metrics indicate that a first expected duration of execution of the first workload on a first number of NPU tiles is within a defined margin of a second expected duration of execution of the first workload on a second number of NPU tiles which is less than the first number of NPU tiles, then the scheduler determines to execute the first workload on the second number of NPU tiles.

Example 29. The apparatus of examples 27 or 28, wherein when the first execution metrics indicate that the first expected duration of execution of the first workload on a first number of NPU tiles is outside the defined margin of the second expected duration of execution of the first workload on the second number of NPU tiles which is less than the first number of NPU tiles, then the scheduler determines to execute the first workload on the first number of NPU tiles.

Example 30. The apparatus of any of examples 27-29, wherein the defined margin comprises a sum of the second expected duration and a percentage of the second expected duration.

Example 31. The apparatus of any of examples 27-30, wherein the scheduler is to determine the number of NPU tiles based additionally on one or more of: a priority of the first workload, an estimated deadline associated with the first workload; a configured scheduling policy; and power or thermal conditions of the plurality of NPU tiles or a processor in which the plurality of NPU tiles are integrated.

Example 32. The apparatus of any of examples 27-31, wherein when the configured scheduling policy is to balance between performance and efficiency, the scheduler is to choose a minimum number of NPU tiles which are capable of meeting the estimated deadline associated with the first workload.

Example 33. The apparatus of any of examples 27-32, wherein when the configured scheduling policy balances between performance and efficiency and when the first execution metrics indicate that a first expected duration of execution of the first workload on a first number of NPU tiles is within a defined margin of a second expected duration of execution of the first workload on a second number of NPU tiles which is less than the first number of NPU tiles, then the scheduler determines to execute the first workload on the second number of NPU tiles.

Example 34. The apparatus of any of examples 27-33, wherein when the configured scheduling policy is designed for maximum efficiency or when the power or thermal conditions indicate that an NPU tile or the processor has exceeded a defined power or temperature threshold, the scheduler is to schedule the first workload on a number of NPU tiles which will consume a minimum amount of power.

Example 35. The apparatus of any of examples 27-34, wherein when the configured scheduling policy is designed for maximum performance, the scheduler is to schedule the first workload on a number of NPU tiles which will complete execution in a shortest duration.

Example 36. A machine-readable medium having program code stored thereon which, when executed by one or more processors, is to cause the one or more processors to perform operations, comprising: evaluating, by a scheduler, first execution metrics associated with a first workload, the first execution metrics to include an indication of an expected duration of time or cycles required to execute the first workload with different numbers of neural processing unit (NPU) tiles of a plurality of NPU tiles; based on the evaluation, determining a first number of the NPU tiles on which to execute the first workload; and causing the first workload to be executed on the first number of NPU tiles.

Example 37. The machine-readable medium of example 36, wherein when the first execution metrics indicate that a first expected duration of execution of the first workload on a first number of NPU tiles is within a defined margin of a second expected duration of execution of the first workload on a second number of NPU tiles which is less than the first number of NPU tiles, then the scheduler determines to execute the first workload on the second number of NPU tiles.

Example 38. The machine-readable medium of examples 36 or 37, wherein when the first execution metrics indicate that the first expected duration of execution of the first workload on a first number of NPU tiles is outside the defined margin of the second expected duration of execution of the first workload on the second number of NPU tiles which is less than the first number of NPU tiles, then the scheduler determines to execute the first workload on the first number of NPU tiles.

Example 39. The machine-readable medium of any of examples 36-38, wherein the defined margin comprises a sum of the second expected duration and a percentage of the second expected duration.

Example 40. The machine-readable medium of any of examples 36-39, wherein the scheduler is to determine the number of NPU tiles based additionally on one or more of: a priority of the first workload, an estimated deadline associated with the first workload; a configured scheduling policy; and power or thermal conditions of the plurality of NPU tiles or a processor in which the plurality of NPU tiles are integrated.

Example 41. The machine-readable medium of any of examples 36-40, wherein when the configured scheduling policy is to balance between performance and efficiency, the scheduler is to choose a minimum number of NPU tiles which are capable of meeting the estimated deadline associated with the first workload.

Example 42. The machine-readable medium of any of examples 36-41, wherein when the configured scheduling policy balances between performance and efficiency and when the first execution metrics indicate that a first expected duration of execution of the first workload on a first number of NPU tiles is within a defined margin of a second expected duration of execution of the first workload on a second number of NPU tiles which is less than the first number of NPU tiles, then the scheduler determines to execute the first workload on the second number of NPU tiles.

Example 43. The machine-readable medium of any of examples 36-42, wherein when the configured scheduling policy is designed for maximum efficiency or when the power or thermal conditions indicate that an NPU tile or the processor has exceeded a defined power or temperature threshold, the scheduler is to schedule the first workload on a number of NPU tiles which will consume a minimum amount of power.

Example 44. The machine-readable medium of any of examples 36-43, wherein when the configured scheduling policy is designed for maximum performance, the scheduler is to schedule the first workload on a number of NPU tiles which will complete execution in a shortest duration.

Example 45. An apparatus comprising: a plurality of neural processing unit (NPU) tiles; a scheduler to schedule a plurality of workloads for execution on the plurality of NPU tiles; and management circuitry to determine a per-tile frequency at which each NPU tile of the plurality of NPU tiles is to operate based, at least in part, a priority level of each workload of the plurality of workloads executed on the plurality of NPU tiles.

Example 46. The apparatus of example 45, further comprising: a plurality of per-tile clock generators coupled to the management circuitry, each per-tile clock generator to generate a per-tile frequency for a different NPU tile of the plurality of NPU based on control signals received from the management circuitry.

Example 47. The apparatus of examples 45 or 46, further comprising a primary NPU clock generator to generate a base clock frequency, each of the per-tile clock generators to scale the base clock frequency or pass through the base clock frequency to generate a corresponding per-tile frequency for a corresponding NPU tile.

Example 48. The apparatus of any of examples 45-47, wherein the management circuitry is to determine relatively higher per-tile clock frequencies for NPU tiles executing relatively higher priority workloads relative to per-tile clock frequencies for NPU tiles executing relatively lower priority workloads of the plurality of workloads.

Example 49. The apparatus of any of examples 45-48, further comprising: an interconnect to couple the plurality of NPU tiles to a memory, wherein the management circuitry is to determine per-tile interconnect bandwidth levels for the plurality of NPU tiles based, at least in part, on the priority levels of the plurality of workloads executed on the plurality of NPU tiles.

Example 50. The apparatus of any of examples 45-49, wherein each workload is to be associated with a quality-of-service (QoS) classification, the management circuitry to determine each per-tile interconnect bandwidth level based, at least in part, on the Qos classification of a workload executed on the NPU tile.

Example 51. The apparatus of any of examples 45-50, further comprising: interconnect arbitration circuitry to control the per-tile interconnect bandwidth levels in accordance with control signals from the management circuitry.

Example 52. A machine-readable medium having program code stored thereon which, when executed by one or more processors, is to cause the one or more processors to perform operations, comprising: scheduling, by a scheduler, a plurality of workloads for execution on a plurality of NPU tiles; determining priority level of each workload of the plurality of workloads; and indicating a per-tile frequency at which each NPU tile of the plurality of NPU tiles is to operate based, at least in part, a priority level of each workload of the plurality of workloads executed on the plurality of NPU tiles.

Example 53. The machine-readable medium of example 52, wherein the one or more processors are to perform additional operations, comprising: controlling a plurality of per-tile clock generators, each per-tile clock generator to generate a per-tile frequency for a different NPU tile of the plurality of NPU tiles based on the indicating.

Example 54. The machine-readable medium of examples 52 or 53, wherein the one or more processors are to perform additional operations, comprising: generating, by a primary NPU clock generator, a base clock frequency, each of the per-tile clock generators to scale the base clock frequency or pass through the base clock frequency to generate a corresponding per-tile frequency for a corresponding NPU tile.

Example 55. The machine-readable medium of any of examples 52-54, the one or more processors are to perform additional operations, comprising: determining relatively higher per-tile clock frequencies for NPU tiles executing relatively higher priority workloads relative to per-tile clock frequencies for NPU tiles executing relatively lower priority workloads of the plurality of workloads.

Example 56. The machine-readable medium of any of examples 52-55, the one or more processors are to perform additional operations, comprising: determining per-tile interconnect bandwidth levels for the plurality of NPU tiles over an interconnect coupling the plurality of NPU tiles to a memory, based, at least in part, on the priority levels of the plurality of workloads executed on the plurality of NPU tiles.

Example 57. The machine-readable medium of any of examples 52-56, wherein each workload of the plurality of workloads is to be associated with a quality-of-service (Qos) classification, the one or more processors to perform additional operations, comprising: determining the per-tile interconnect bandwidth level based, at least in part, on the Qos classification of a workload executed on a respective NPU tile.

Example 58. The machine-readable medium of any of examples 52-57, the one or more processors are to perform additional operations, comprising: controlling the per-tile interconnect bandwidth levels in accordance with control signals received from management circuitry.

Embodiments of this disclosure may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the Figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals-such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of this disclosure may be implemented using different combinations of software, firmware, and/or hardware. Throughout this detailed description, for the purposes of explanation, numerous specific details were set forth in order to provide a thorough understanding of the present invention. It will be apparent, however, to one skilled in the art that this disclosure may be practiced without some of these specific details. In certain instances, well known structures and functions were not described in elaborate detail in order to avoid obscuring the subject matter of the present invention. Accordingly, the scope and spirit of this disclosure should be judged in terms of the claims which follow.

What is claimed is:

1. An apparatus comprising:
a plurality of neural processing unit (NPU) tiles; and
a scheduler to schedule a plurality of workloads for execution on the plurality of NPU tiles,
where in the scheduler configured to:
schedule a first workload associated with a first priority for execution on at least a first NPU tile of the plurality of NPU tiles; and
responsive to an indication of a second workload associated with a second priority which is higher than the first priority submitted for execution, determining whether to: preempt the first workload to execute the second workload on the first NPU tile, execute the second workload on a second NPU tile in parallel with the first workload, or provide a grace period for the first workload to complete execution before executing the second workload on the first NPU tile,
wherein the determining based, at least in part, on one or more of: (i) whether there are any idle NPU tiles in the plurality of NPU tiles; (ii) estimated deadlines associated with the first workload and/or the second workload; (iii) a scheduling policy associated with workloads executing at different priority levels; and (iv) current power or thermal conditions of the plurality of NPU tiles or a processor in which the plurality of NPU tiles are integrated.

2. The apparatus of claim 1, wherein, based on an estimated deadline associated with the second workload, the scheduler is to provide a grace period for the first workload to complete execution on the first NPU tile before executing the second workload on the first NPU tile, the grace period having a duration selected so that the execution of the second workload is completed in accordance with the estimated deadline associated with the second workload.

3. The apparatus of claim 2, wherein the scheduler is to:
cause a first context state associated with the first workload to be saved to memory and/or persistent storage; and
preempt the first workload to execute the second workload on the first NPU tile when the first workload has not completed execution in accordance with the grace period.

4. The apparatus of claim 3, wherein, following execution of the second workload, the scheduler is to:
resume execution of the first workload on the first NPU tile and cause the first context state to be restored to the first NPU tile from the memory and/or persistent storage.

5. The apparatus of claim 1, wherein the indication of the second workload is to be provided to the scheduler in a doorbell register or memory location updated by a host processor to indicate the second workload.

6. The apparatus of claim 1, wherein the first workload is associated with a first user context and the second workload is associated with a second user context, and wherein during execution of the first workload, the scheduler is to track a first context state corresponding to the first user context and during execution of the second workload, the scheduler is to track a second context state corresponding to the second user context.

7. The apparatus of claim 6, wherein the scheduler is to perform per-user context timeout tracking, comprising a first period of time or first number of execution cycles within which the first user context must complete execution and a second period of time or second number of execution cycles within which the second user context must complete execution.

8. The apparatus of claim 7, wherein if the first user context fails to complete execution within the first period of time or first number of execution cycles, then the scheduler is to generate a notification to a host processor, which is to subsequently cause a reset of at least the first NPU tile.

9. The apparatus of claim 6, wherein the first context state includes any errors generated during execution of the first workload and the second context state includes any errors generated during execution of the second workload.

10. The apparatus of claim 1, wherein when the scheduling policy indicates that any workload executing at the first priority will not be scheduled in parallel with any other workload, then the scheduler is to preempt the first workload in favor of the second workload.

11. The apparatus of claim 1, wherein if there is at least a second NPU tile which is idle and which is capable of executing the second workload in accordance with an estimated deadline associated with the second workload, then the scheduler is to schedule the second workload for execution on the second NPU tile, the second workload to be executed on the second NPU tile in parallel with the first workload being executed on the first NPU tile.

12. The apparatus of claim 1, wherein the scheduler is to determine to not execute the second workload in parallel with the first workload and/or is to determine to reduce a frequency of one or more of the plurality of NPU tiles if the current power or thermal conditions of the plurality of NPU tiles indicate that a power threshold or temperature threshold is exceeded.

13. A machine-readable medium having program code stored thereon which, when executed by one or more processors, is to cause the one or more processors to perform operations, comprising:
scheduling, by a scheduler, a plurality of workloads for execution on a plurality of NPU tiles, wherein scheduling further comprises:
scheduling a first workload associated with a first priority for execution on at least a first NPU tile of the plurality of NPU tiles; and
determining, responsive to an indication of a second workload associated with a second priority which is higher than the first priority submitted for execution, whether to: preempt the first workload to execute the second workload on the first NPU tile, execute the second workload on a second NPU tile in parallel with the first workload, or provide a grace period for the first workload to complete execution before executing the second workload on the first NPU tile, the determining based, at least in part, on one or more of: (i) whether there are any idle NPU tiles in the plurality of NPU tiles; (ii) estimated deadlines associated with the first workload and/or the second workload; (iii) a scheduling policy associated with workloads executing at different priority levels; and (iv) current power or thermal conditions of the plurality of NPU tiles or a processor in which the plurality of NPU tiles are integrated.

14. The machine-readable medium of claim 13, wherein based on an estimated deadline associated with the second workload, providing, by the scheduler, a grace period for the first workload to complete execution on the first NPU tile before executing the second workload on the first NPU tile, the grace period having a duration selected to ensure that the estimated deadline associated with the second workload will be met.

15. The machine-readable medium of claim 14, wherein the scheduler is to preempt the first workload to execute the second workload on the first NPU tile when the first workload has not completed execution in accordance with the grace period.

16. The machine-readable medium of claim 15, wherein to preempt the first workload, the scheduler is to cause a first context state associated with the first workload to be saved to memory and/or persistent storage.

17. The machine-readable medium of claim 16, wherein following execution of the second workload, the scheduler is to resume execution of the first workload on the first NPU tile, the scheduler to cause the first context state to be restored to the first NPU tile from the memory and/or persistent storage.

18. The machine-readable medium of claim 13, wherein the indication of the second workload is to be provided to the scheduler in a doorbell register or memory location updated by a host processor to indicate the second workload.

19. The machine-readable medium of claim 13, wherein the first workload is associated with a first user context and the second workload is associated with a second user context, and wherein during execution of the first workload, the scheduler is to track a first context state corresponding to the first user context and during execution of the second workload, the scheduler is to track a second context state corresponding to the second user context.
